(19) United States
(12) Patent Application Publication
(10) Pub. No.: US 2025/0190284 A1
(43) Pub. Date: Jun. 12, 2025

(54) METHOD AND SYSTEM UTILIZING A METAGRAPH PATTERN MATCHING CHIP

(71) Applicant: TrueAGI, Seattle, WA (US)

(72) Inventors: Benjamin Goertzel, Vashon, WA (US); Rachel St. Clair, Delray Beach, FL (US); Andre Senna, Nova Lima (BR)

(73) Assignee: TrueAGI, Seattle, WA (US)

(21) Appl. No.: 18/977,037

(22) Filed: Dec. 11, 2024

Related U.S. Application Data
(60) Provisional application No. 63/608,522, filed on Dec. 11, 2023.

(51) Int. Cl. G06F 9/54; G06F 8/41; G06F 18/22

(52) U.S. Cl. CPC G06F 9/541; G06F 8/41; G06F 18/22

(57) ABSTRACT

A method and system that utilizes a metagraph pattern matching chip (MPMC), which includes on-chip and off-chip software. The chip is designed with parallel MIMD cores optimized for artificial general intelligence (AGI) software programs. Specialized on-chip memory caches, each attached to their own specialized processing units, allow for dynamic updating and a mixture of discrete and floating-point operations. Additional software provides the interface between the CPU and MPMC to manage cache. The result is faster execution time for any graph-based architectures and implementation of functional programming interpreters.

### TECHNICAL FIELD

The exemplary embodiment relates to a method and system utilizing a metagraph pattern matching chip and finds particular application in connection artificial general intelligence architectures. However, it is to be appreciated that the present exemplary embodiment is also amenable to other like applications.

### BACKGROUND

One of the most commonly used means for artificial general intelligence (AGI) architectures are knowledge graphs. In such programs an efficient search of patterns existing in a metagraph (i.e., a subset of the entire graph) needs to be matched to the corresponding pattern in a larger metagraph.

There is no current hardware that utilizes a specialized resource layout to directly enhance execution time of pattern matching search in AGI and functional programming interpreters. This is directly due to the lack of appropriate memory and logic architecture, flexibility of processing unit operation types, and specialized resource management to minimize local memory access.

Therefore, there is a need for a system in which the hardware design can be leveraged with specialized logic to compute the architecture design and how to manage the updating processes for a dynamically changing graph.

### BRIEF DESCRIPTION

Various details of the present disclosure are hereinafter summarized to provide a basic understanding. This summary is not an extensive overview of the disclosure and is intended neither to identify certain elements of the disclosure, nor to delineate the scope thereof. Rather, the primary purpose of the summary is to present certain concepts of the disclosure in a simplified form prior to the more detailed description that is presented hereinafter.

Described herein is a system and method of expedited program execution in computer systems, and more specifically, this disclosure pertains to specialized logic agents, latticed cache memory, and an asynchronous management protocol, configured in such a way so as to quickly integrate memory and logic in a novel hardware architecture layout. Specialized logic is also described to ensure information flow for search and match operations on the processor hardware are executed in an efficient manner.

The exemplary system and method utilizes a metagraph pattern matching chip (MPMC), which includes on-chip and off-chip software. The chip is designed with parallel MIMD cores optimized for artificial general intelligence (AGI) software programs. Specialized on-chip memory caches, each attached to their own specialized processing units, allow for dynamic updating and a mixture of discrete and floating-point operations. Additional software provides the interface between the CPU and MPMC to manage cache. The result is faster execution time for any graph-based architecture and implementation of functional programming interpreters.

In accordance with an aspect of the exemplary embodiment, a system for expedited program execution in computer systems utilizing a metagraph pattern matching chip is provided. The system includes a software application program comprising data and instructions to complete a desired program outcome; a compiler comprising compiler software, a compiler graph partitioner, and a traversal manager, wherein the compiler is configured at least to decompose instructions into two identical copies of a graph structure of nodes and edges to create modified instructions; a device driver comprising software, a device graph partitioner and a cache manager to execute the modified instructions onto hardware; and hardware comprising a double mesh structure that includes one or more double mesh hybrid memory cubes, each double mesh hybrid memory cube comprising one or more logic units and one or more memory caches.

Optionally, each double mesh hybrid memory cube comprises at least one vault and at least one RAM module.

Optionally, the one or more memory caches comprise at least one edge buffer memory cache, and the at least one vault comprises a plurality of specialized logic unit processors that are connected through an interconnect mesh to the at least one edge buffer memory cache.

Optionally, the at least one edge buffer memory cache is configured to at least consider a list of pending edges that are sites of active search in the application program, transmit information to and from the specialized logic unit processors via an interconnect mesh fabric, and store information necessary for the at least one vault.

Optionally, the specialized logic unit processors are configured to compute operations on data stored in the at least one edge buffer memory cache, and wherein the edge buffer memory cache includes a list of edges that are active sites of search in a pattern matching algorithm.

Optionally, the system further comprises a cache manager that uses a list of edges that are active sites of search in the pattern matching algorithm, wherein the cache manager uses compiled application specific instructions from compiled instructions and microcode for managing when edges are fetched or released from cube RAM and put into the memory cache via a driver, wherein the cache manager is configured to run the behavior of edge buffers and runs on the hypercube vault.

Optionally, the traversal manager is configured to: execute order and application specific instructions executed by the cache manager; generate information by distinguishing vault edges, hypercube edges, and in-between hypercube edges by confirming with the atomic access to the reference count associated with each edge before processing in that order; and store the information in the memory cache.

Optionally, the traversal manager is configured to inform the application of the order for updating information in the at least one vault, in the hybrid memory cubes, and across the hybrid memory cubes.

Optionally, the compiler graph partitioner and the driver graph partitioner are configured to manage dynamic changes in a graph; allow execution of pattern matching in the application program according to records of edge access location frequency; and update rules across the double mesh architecture and associated memories.

Optionally, the compiler graph partitioner is configured to partition the graph before updating and executing search in which a graph partitioner protocol can be employed.

Optionally, the compiler graph partitioner is further configured to dynamically update the graph after an identical copy of the graph is made by accessing the record of edge access location frequency combined with update position instructions provided by cache compiled instructions of the application, including data from the traversal manager and a cache manager.

Optionally, a device driver portion of a cache manager is configured to execute updating positions and the movements of either cloning or moving edges in memory caches, hypercube RAM, or the global RAM.

Optionally, the system is configured to fetch edges from a primary RAM on a cube and put the edges into the cache memory on the cube according to a caching policy, wherein the caching policy is driven by the application and by one or more internal rules.

Optionally, if there are too many matches to fit in the cache, the processor of each cube is configured to determine long term importance and short term importance values, including propagation of values between the code running in each cube and in neighboring cubes, to determine which edges will be fetched.

Optionally, a dynamic metagraph may be stored in the memory caches and the graph partitioners are configured to partition sub-metagraphs among cubes dynamically.

### BRIEF DESCRIPTION OF THE DRAWINGS

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure will be set forth in the following detailed description of the disclosure when considered in conjunction with the drawings, in which:

FIG. 1 is a schematic diagram that depicts the overall flow of information processing as separated into software and hardware components in accordance with aspects of the exemplary embodiment;

FIG. 2 depicts a diagram of the hardware components and layout that computes the software in accordance with aspects of the exemplary embodiment;

FIG. 3 describes the components of a specialized logic processor in accordance with aspects of the exemplary embodiment;

FIG. 4 shows the layout of an edge buffer memory cache in accordance with aspects of the exemplary embodiment;

FIG. 5 is a flow diagram of the cache manager software in accordance with aspects of the exemplary embodiment;

FIG. 6 illustrates the traversal manager software in accordance with aspects of the exemplary embodiment; and

FIG. 7 depicts the graph partitioning in accordance with aspects of the exemplary embodiment.

### DETAILED DESCRIPTION

In the AGI architecture Hyperon, the technique of pattern matching is a current bottleneck for the system to run in practical time. Hyperon's key architectural feature, inherited from OpenCog, is a large, distributed knowledge metagraph called the edgespace. Various AI algorithms are executed against edgespace, mainly implemented in a custom functional programming language called MeTTA (Meta Type Talk). The key operational property of most relevant MeTTA programs, from the hardware design standpoint, is that the vast majority of time complexity is consumed in pattern-matching operations against the edgespace. Some of this pattern matching involves the distributed edgespace, which includes a persistence component. But a large percentage of pattern matching involves matching against portions of the edgespace that are cached in random-access memory (RAM) hardware on various machines involved in a Hyperon network.

Similarly, functional programming interpreters often incur similar processing constraints. In this use case, data types are checked extensively during a functional program execution. In functional programming, the source code is transformed into pointers and links which connect the elements of the source code into a set of operations to be executed in order by a chaining process. During this process, pattern matching is used to substitute the results of one rule application to another. Since this process needs to occur at runtime, as is the nature of an interpreter, the pattern search creates a bottleneck for some programs' execution. Without explicitly coding elements of the program to run in a multithreaded manner, code execution is slowed.

The overarching methodology in both use-cases is pattern matching search. Currently, approaches commonly use either GPU (graphics processing unit), CPU (central processing unit), or IPU (intelligence processing unit) hardware components. In all cases, the hardware is employed to search in parallel different nodes of the metagraphs and compare for a match. Once a match is found, the metagraph is edited. This requires a continual process of high-volume back-and-forth computing between memory and processing cores.

The main method of increasing the execution time of pattern search is by employing parallelism in multiple instruction, multiple data (MIMD) processing fashion. While this approach has seen success in computing desired programs, the methodology would greatly benefit from specialized logic units customized for this methodology to accelerate the process amongst related applications.

In MIMD architectures, processing cores use a shared or distributed memory to access information while running different computations in parallel. GPUs are single instruction, multiple data (SIMD), while CPUs and IPUs are commonly MIMD. For SIMD graph search, the drawback is pattern matching in graphs relies on doing different kinds of computations since different processing nodes are checking different sections of the graph. Thus, MIMD is a more natural architecture for graph operations.

As the graphs of most AGI-based programs are memory intensive, the shared memory model of current CPUs, often offset by many other operating system computations, is not large enough to search the graph as quickly as desired. Even though the distributed memory model of current IPUs is more affording to these types of large graph applications, the issue is that, to date, there is not enough on-chip cache to contain the larger metagraphs needing to be searched and the specialized logic units are designed to process images rather than compare and edit graph nodes. The distributed memory in IPUs is commonly stored in mesh models which use a 2-D structure to distribute memory caches. This distribution is limited due to physical space as compared to hypercube distributed memory which uses a 3-D space, making hypercubes more suited for the related applications.

In addition to memory and processing architecture, the types of computations that processing units can do are sub-optimal for optimizing pattern matching as described in the current context. Both floating-point and fixed-point operations are needed. Current IPU architectures are traditionally designed for floating-point operations, which due to precision overhead, increases the physical architecture space needed. Discrete operations require less space in physical architecture design. A flexible utilization of both fixed-point and floating-point would take advantage of physical layout space, which would afford larger memory caches, a design choice not currently seen in standard architectures.

The continual pulling of information into local memory for the logic to compute equivalency between the larger graph and the portion of graph creates a performance bottleneck. Some patterns need to be completely checked in that until the last portion of the sub-graph is checked, it is not known whether there is a match. This creates a scenario in which a considerable amount of unnecessary computation is done before the pattern match check is failed.

Thus, the most critical aspect of speeding up Hyperon operations is speeding up pattern matching against in-RAM knowledge metagraphs. Further, the type of pattern matching needed is quite general and complex with subtleties—inclusive of and in some ways going beyond the pattern matching required within modern functional programming interpreters. Patterns may involve interdependent variables, and variables matched to entire sub-metagraphs.

Various pattern-matching algorithms are feasible and interesting to explore, but the standard workhorse as embodied in the current OpenCog Pattern Matcher is exploratory graph traversal with backtracking. Parallelization of backtracking has been applied for instance in a logic programming context. In essence one uses multiple backtracking agents, each of which maintains a queue of promising nodes to expand, and one then allows some sharing of promising nodes among agents. Various techniques exist for minimizing the amount of communication needed among the multiple agents. The same basic parallelization techniques tend to hold if one goes beyond standard backtracking to other similar but more sophisticated search methods.

This process has been utilized across many technical applications, such as other AGI frameworks (e.g., AIGO), and functional programming languages (e.g., Haskell). However, their adaptability largely relies on increasing time to compute as the graph architecture scales in size, which is necessary for continual learning in AGI, and as the program size of a functional program grows, as is often needed for increased complexity handling. The exemplary embodiment thus mitigates the resources needed to compute (i.e., memory and logic) while reconsidering the architectural layout that can be leveraged in such cases for accelerated execution speeds.

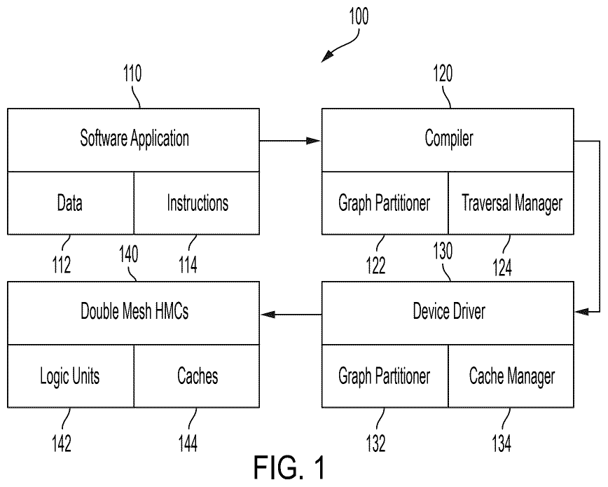

Referring now to the drawings wherein the showings are for purposes of illustrating the exemplary embodiments only and not for purposes of limiting the claimed subject matter, FIG. 1 depicts the overall flow of information processing 100 as separated into software and hardware components. Described below is the system specification, architectural design, function, and logic gate design, as well as the software design to be used on the completed accelerator.

The software application program 110 generally contains data 112 and instructions 114 to complete the desired program outcome. The compiler 120, which is a computer program that translates computer code written in one programming language (the source language) into another language, includes at least basic compiler software (not shown) along with a graph partitioner 122 and a traversal manager 124, which decomposes instructions into two identical copies of the graph structure of nodes and edges. This information is passed to the device driver 130, which includes the usual related software as well as the addition of an extension 132 of the graph partitioner and a cache manager 134 to execute the modified instructions onto the hardware. At this point, the data then reaches the hardware, i.e., one or more double mesh hybrid memory cubes (HMCs) 140, which include one or more logic units 142 and caches 144.

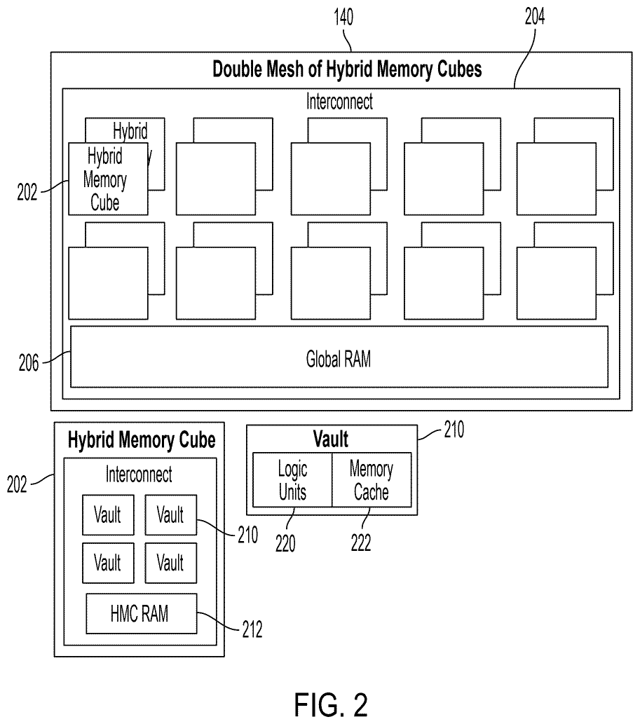

FIG. 2 illustrates the hardware layout of the double mesh structure 140 containing multiple hybrid memory cubes 202, or hypercubes, connected with the interconnect mesh 204 and a global RAM module 206. As shown in FIG. 2, each hybrid memory cube generally consists of multiple vaults 210 and at least one RAM module 212. Each vault 210 generally includes multiple specialized logic unit processors 220 connected through the interconnect mesh 204 to at least one edge buffer memory cache 222.

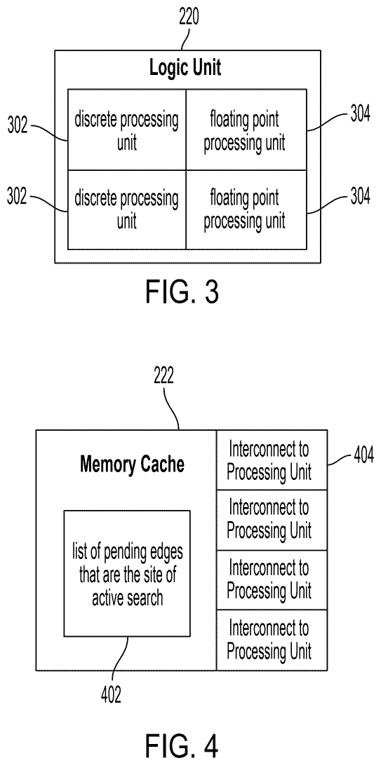

FIG. 3 shows the components of one of the specialized logic unit processors 220, which enables computations of the application program on the hardware and, in turn, contains multiple processing units. As shown in FIG. 3, the specialized logic unit processor 220 typically includes any number of discrete processing units 302 and any number of floating-point processing units 304. These units can be allocated for discrete or floating-point operations by the traversal manager software instructions.

FIG. 4 shows the layout of the edge buffer memory cache 222, which at least considers the list of pending edges that are sites of active search 402 in the application program, transmits information to and from each processing unit via interconnect mesh fabric 404, and stores information necessary for each vault 210. These processing units compute operations on data stored in the edge buffer memory cache 222. In the edge buffer memory cache 222, there remains a list of edges that are active sites of search in the pattern matching algorithm.

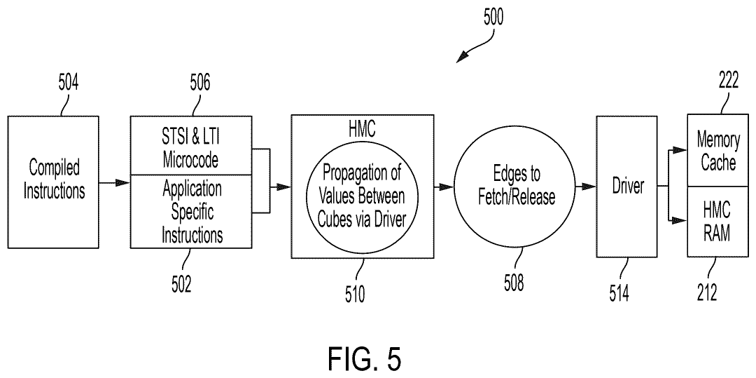

The list of edges that are active sites of search in the pattern matching algorithm is used by the cache manager 500, which is shown schematically in FIG. 5. The cache manager 500 uses both compiled application specific instructions 502 from compiled instructions 504 and microcode using, for example, STSI (Store System Information instruction) and LTI 506 for managing when edges are fetched or released 508 from cube RAM 510, i.e., propagation of values between cubes via driver, and put into the memory cache 222/HMC RAM 212 (see FIG. 4) via a driver 514. FIG. 5 describes the cache manager software, which considers and manages how the caches will be filled and emptied as the application process runs using both application specific instructions and microcode. The cache manager 500 is also responsible for running the behavior of edge buffers and itself runs on the hypercube vaults.

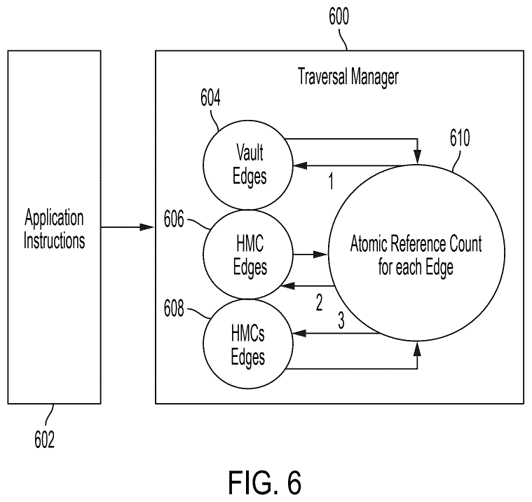

FIG. 6 shows the traversal manager 600. The order and application specific instructions 602 executed by the cache manager 500 are determined, in part, by the traversal manager 600. The traversal manager 600 distinguishes vault edges 604, hypercube edges 606, and in-between hypercube edges 608, by confirming 610 with the atomic access to the reference count associated with each edge before processing in that order. This information is then stored in the memory cache 222. The traversal manager 600 thus informs the application as to the order for updating information in vaults 210, in hybrid memory cubes 202, and across hybrid memory cubes 608.

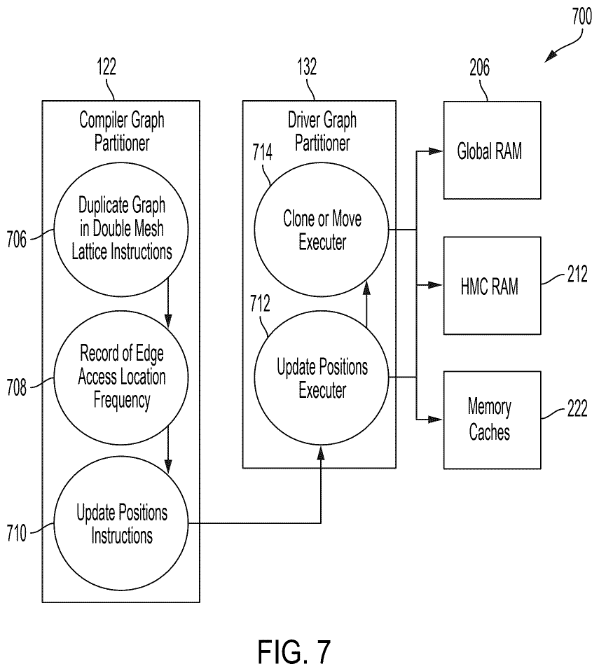

FIG. 7 depicts the graph partitioning process 700, which uses at least the compiler graph partitioner 120 and the driver graph partitioner 122 to manage dynamic changes in the graph and allows execution of pattern matching in the application program according to records of edge access location frequency and update rules across the double mesh architecture and associated memories. Partitioning the graph occurs before updating and executing search in which the graph partitioner protocol can be employed. Once an identical copy of the graph is made (706), the ability to dynamically update the graph using the graph partitioner occurs by accessing the record of edge access location frequency (708) combined with the update position instruction provided by cache compiled instructions of the application (710), including data from the traversal and cache managers. The device driver portion of the cache manager then executes updating positions (712) and the movements of either cloning or moving edges (714) in memory caches 222, hypercube RAM 212, or in some cases the global RAM 206. One copy of the graph is used for pattern matching while the other is being updated, or in the case of lack of update, the graph partitioner employs both graphs for pattern matching or application specific computations.

Accordingly, the disclosed system and methodology is directly applicable to common AGI architectures, functional program interpreters, and any program that employs a graph-based search. The hardware architecture natural for optimizing this sort of workload is a MIMD distributed hypercube architecture (implementing independent, but communicating, search agents), embedded in a processor-in-RAM framework, since nearly all the agents are doing is reading from the in-RAM metagraph, and doing a bit of metagraph editing. The software infrastructure relies on optimizing hardware resource use with specialized logic agents and asynchronous cache management.

The exemplary system enables expedited search and pattern matching within a processor-in-RAM-like hardware architecture. Embodiments of the system allow users to access large memory caches and process multiple instructions in parallel with specialized logic designed for fast search with asynchronous updating to minimize search down-time. There are many possible approaches for leveraging the logic flow foundations of pattern matching and functional program execution with parallelized and expedited MIMD processing abetted by large caches attached to small clusters of specialized logic units which employ asynchronous updating. Described herein are preferred approaches that allow multiple search and compute procedures that can be optimized in the described hardware architecture and related software infrastructure.

The underlying approach of processor-in-RAM computing is to manage logic and cache in a fashion that provides a fast interconnect between the memory cache and logic nodes of the layout. Core considerations lie in the speed of the interconnect which allows communication between processing elements and the availability of memory to individual processing elements.

With respect to the exemplary embodiment described herein, the core modification is needed to replace the specialized logic unit with a different specialized logic unit that has a cache containing a “metagraph edge buffer” and carries out pattern matching search against the portion of the metagraph associated with the vault.

The metagraph edge buffer contains the list of pending edges that are the site of active search by the processing unit, among other things. The specific operation of this edge buffer is an important aspect of the exemplary embodiment, namely, the MPMC. The standard cache logic of existing chips is not adequately customized for the metagraph pattern matching application; special tuning of the behavior of this buffer will be highly valuable for optimizing performance and will be performed in a cache manager process running on the HMC's processor units.

Preferably, instead of a single large, specialized logic unit within each cube, it may be optimal to have a number of smaller logic units within the cube, but all connected to the same edge-buffer cache. In that case, each of the small logic units hosts an individual backtracking agent.

The speed of the interconnects between the vaults in a single HMC and also between the HMCs in the double-mesh becomes important here, of course, because often the search within one vault or HMC will lead to some edge stored in another vault or HMC, which means an edge in one processing unit's edge buffer nudges some connected edge to get pushed into another processing unit's edge buffer.

The search algorithm needs to be made conscious of the distinction between vaults and between HMCs, so that search steps proceed preferentially within a vault, secondarily within an HMC, and tertiarily across HMCs.

Another feature in the design of the MPMC processing logic is the number and efficiency of the atomic operation units on each processor. These are critical when doing traversals from one metagraph edge to another, because the dynamic nature of the metagraph means that the edges previously connected to edge E may no longer be there when one tries to access them. This means that in some sense the links between metagraph edges can be considered as “weak pointers,” implying that edge traversal requires an atomic access to the reference count associated with an edge, to see if it is zero. Performance of backtracking search or other forms of traversal may hen end up gated by the number of atomic units available and their performance.

As discussed above, edges are fetched from the primary RAM on a cube and put into the cache memory on that cube by the cache manager process. The caching policy is driven by the application itself and by the cache manager's internal rules. Applications can request the cache manager to fetch a specific set of edges to guarantee they are available in cache. Applications can also release sets of edges indicating to cache manager that those edges are no longer required (at least in the near future) so they can safely be removed from the cache and merged back to the primary RAM. When the cache is filling up, the cache manager can also decide to remove sets of edges from the cache merging them back into the main RAM.

AI applications can drive the caching policy by explicitly requesting the fetch and release of groups of edges that match certain patterns. If there are too many matches to fit in cache, the cache manager can use values called STI (Short Term Importance) and LTI (Long Term Importance) to decide which edges will actually be fetched. Calculation of STI and LTI values must be carried out by code running in the processor of each HMC, including propagation of values between the code running in each cube and neighboring cubes.

The metagraph stored on an MPMC will in general be dynamic, so that the partitioning of sub-metagraphs among HMCs ultimately needs to be dynamic. This involves two aspects: figuring out what to move where, and practical execution of the movement.

For figuring out what to move, an algorithm may be used whereby when an edge E in HMC X is accessed more often via search from within Y than via search from within X, it is considered for movement from X to Y. It can also be considered to sometimes have clones of the same edge E in different HMCs, if the same edge needs to be accessed very frequently from edges in both HMC X and HMC Y. The annotations needed to record the frequency of search of edge E from within HMC X or Vault V, and to note that edge E1 is a clone of Edge E, can be stored in the knowledge metagraph itself, and accessed and updated using the same mechanisms used for the other content in the metagraph.

Actual movement is often tricky because when nodes or edges are moving from one cube to another, those cubes are temporarily out of commission for pattern matching. One option is to have an architecture involving two lattices, both containing the same metagraph. Periodically, the most recently refreshed lattice (let's call it A) will seed a rewrite of the other lattice (B), in which the positions of nodes and edges in B are determined by the positions in A post-processed according to the relevant annotations in A. In turn, A can keep doing pattern matching while it is being copied to B, but B cannot do pattern matching while it is being copied into.

With this two-lattice design, if the metagraph involved is not highly dynamic, then most of the time one is just doing redundant pattern matching on two lattices. In cases where the pattern matching involves stochastic search this redundancy may be perfectly efficient—it is a way of getting more samples. If the metagraph is highly dynamic, then most of the time only one of the lattices will be actively doing pattern matching, and the other will be getting imprinted with a recently re-organized version of the metagraph.

With respect to the exemplary embodiment, various modules are employed to navigate the disclosed hard architecture layout and associated software. Within these modules, specialized logic units are employed to execute speedy search and an architectural design element is employed to provide a method for asynchronous graph update to reduce search downtime. In doing so, the program disclosed is directly implemented in hardware. The result is an optimized hardware architecture and code program that optimizes for speed with moderate power and memory usage. The result is a system that can quickly match patterns during software program execution. The desired factors of the system are to access large memory caches to process multiple instructions in parallel, allocate processing units and memory caches with minimal downtown, traverse information edges without error, and do so as quickly as possible.

The exemplary system may thus include one or more computing devices, each of which may be a PC, such as a desktop, a laptop, server computer, microprocessor, cellular telephone, tablet computer, combination thereof, or other computing device capable of executing instructions for performing the exemplary method.

The memory of the computing device(s) may include any type of non-transitory computer readable medium such as random-access memory (RAM), read only memory (ROM), magnetic disk or tape, optical disk, flash memory, or holographic memory. The input/output interfaces may comprise a modulator/demodulator (MODEM) a router, a cable, and/or an Ethernet port. The digital processors of the computing device(s) can be variously embodied, such as by a single-core processor, a dual-core processor (or more generally by a multiple-core processor), a digital processor and cooperating math coprocessor, a digital controller, or the like.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The methods described herein and illustrated in the figures may be at least partially implemented in a computer program product or products that may be executed on one or more computers. The computer program product(s) may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use.

Alternatively, the methods may be implemented in transitory media, such as a transmittable carrier wave in which the control program is embodied as a data signal using transmission media, such as acoustic or light waves, such as those generated during radio wave and infrared data communications, and the like.

The exemplary methods may be implemented on one or more general purpose computers, special purpose computers, a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like.

As will be appreciated, the steps of the methods need not all proceed in the order illustrated and fewer, more, or different steps may be performed.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A system for expedited program execution in computer systems utilizing a metagraph pattern matching chip, the system comprising:
a software application program comprising data and instructions to complete a desired program outcome;
a compiler comprising compiler software, a compiler graph partitioner, and a traversal manager, wherein the compiler is configured at least to decompose instructions into two identical copies of a graph structure of nodes and edges to create modified instructions;
a device driver comprising software, a device graph partitioner and a cache manager to execute the modified instructions onto hardware; and
hardware comprising a double mesh structure that includes one or more double mesh hybrid memory cubes, each double mesh hybrid memory cube comprising one or more logic units and one or more memory caches.

2. The system of claim 1, wherein each double mesh hybrid memory cube comprises at least one vault and at least one RAM module.

3. The system of claim 2, wherein the one or more memory caches comprise at least one edge buffer memory cache, and the at least one vault comprises a plurality of specialized logic unit processors that are connected through an interconnect mesh to the at least one edge buffer memory cache.

4. The system of claim 3, wherein:
the at least one edge buffer memory cache is configured to at least consider a list of pending edges that are sites of active search in the application program, transmit information to and from the specialized logic unit processors via an interconnect mesh fabric, and store information necessary for the at least one vault.

5. The system of claim 4, wherein the specialized logic unit processors are configured to compute operations on data stored in the at least one edge buffer memory cache, and wherein the edge buffer memory cache includes a list of edges that are active sites of search in a pattern matching algorithm.

6. The system of claim 5, further comprising a cache manager that uses a list of edges that are active sites of search in the pattern matching algorithm, wherein the cache manager uses compiled application specific instructions from compiled instructions and microcode for managing when edges are fetched or released from cube RAM and put into the memory cache via a driver, wherein the cache manager is configured to run the behavior of edge buffers and runs on the hypercube vault.

7. The system of claim 5, wherein the traversal manager is configured to:
execute order and application specific instructions executed by the cache manager;
generate information by distinguishing vault edges, hypercube edges, and in-between hypercube edges by confirming with the atomic access to the reference count associated with each edge before processing in that order;
store the information in the memory cache.

8. The system of claim 1, wherein the traversal manager is configured to inform the application of the order for updating information in the at least one vault, in the hybrid memory cubes, and across the hybrid memory cubes.

9. The system of claim 1, wherein:
the compiler graph partitioner and the driver graph partitioner are configured to to:
manage dynamic changes in a graph;
allow execution of pattern matching in the application program according to records of edge access location frequency; and
update rules across the double mesh architecture and associated memories.

10. The system of claim 1, wherein:
the compiler graph partitioner is configured to partition the graph before updating and executing search in which a graph partitioner protocol can be employed.

11. The system of claim 10, wherein the compiler graph partitioner is further configured to dynamically update the graph after an identical copy of the graph is made by accessing the record of edge access location frequency combined with update position instructions provided by cache compiled instructions of the application, including data from the traversal manager and a cache manager.

12. The system of claim 1, wherein a device driver portion of a cache manager is configured to execute updating positions and the movements of either cloning or moving edges in memory caches, hypercube RAM, or the global RAM.

13. The system of claim 1, wherein the system is configured to fetch edges from a primary RAM on a cube and put the edges into the cache memory on the cube according to a caching policy, wherein the caching policy is driven by the application and by one or more internal rules.

14. The system of claim 1, wherein if there are too many matches to fit in the cache, the processor of each cube is configured to determine long term importance and short term importance values, including propagation of values between the code running in each cube and in neighboring cubes, to determine which edges will be fetched.

15. The system of claim 1, wherein a dynamic metagraph is stored in the memory caches and the graph partitioners are configured to partition sub-metagraphs among cubes dynamically.
